(19) United States
(12) Patent Application Publication
(10) Pub. No.: US 2007/0077534 A1
(43) Pub. Date: Apr. 5, 2007

(54) Blank and intermediate article for the production of a dental prosthetic item and process for the production thereof

(76) Inventors: Gunter Saliger, Bensheim (DE); Joachim Pfeifer, Bensheim (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/571,257

(22) PCT Filed: Sep. 13, 2004
(86) PCT No.: PCT/EP04/52147

§ 371 Date: Mar. 9, 2006

(30) Foreign Application Priority Data
Sep. 11, 2003 (DE) 103 42 231.5

(51) Int. Cl. A61C 13/00; A61C 5/08; B29B 7/00

(52) U.S. Cl. 433/167; 433/202.1; 433/222.1; 428/542.8

(57) ABSTRACT

The invention relates to a blank for the production of a dental prosthesis. The blank has a frame structure with open-pored cavities. Other objects of the invention are a dental prosthesis produced from a blank and a method for the production of a blank and/or dental prosthesis.

### TECHNICAL FIELD

The invention relates to a blank and an intermediate article for the production of a dental prosthetic item, in particular from metallic materials, and to a process for the production of the dental prosthetic item.

In dental technology, use is made of a large number of metal alloys for the production of crowns and bridges. Caps and frameworks or complete restorations are produced from these metals by casting techniques employing the lost mold method. These are then either used directly or after optional veneering with ceramics or plastics materials.

Customary materials are AuPt, CrCo, or NiCo alloys and titanium. The degree of distribution of the individual materials is very strongly marked by local habits. In certain markets, dental prosthetic items are to a very large extent produced from high gold alloys.

In EP 0 214 341, a process for the production of a metallic dental prosthesis is disclosed in which a mixture of metal powders is compounded to a spreadable mass with a mixing fluid and then sintered. In this process, the metal powder mixture is modeled on a model serving as a firing support and is sintered on the model. Essentially the same technique is described in EP 0 373 380 A2.

In addition to this traditional process, various dental alloys can be directly finely ground using CAD/CAM machines, but this procedure suffers from the drawback that the milled item in its final form makes up only about 20 to 30% of the total volume of material removed.

Processes are also known in which frameworks are produced from porous sintered ceramic blocks which are infiltrated with a lanthanum glass. In another process, a porous Pt foil is applied to a tooth stump, which is then infiltrated with gold so that a cap made of a mixture of gold and platinum results.

Another route is shown in DE 199 01 643 A1, in which a shaped article is built up layerwise from a sinterable powder by exposing each layer of the powder to the energy of a laser beam to produce local sintering of the layer.

In the dental ceramics field, it is known from DE 199 30 564 A1 to stamp a ceramic blank from a pulverulent ceramic raw material, to impart an inner contour and/or an outer contour to this ceramic blank by means of machining processes and to sinter the machined green ceramic blank to give a high-strength shaped ceramic item. The ceramic material used in this case is such that a pressing aid can be employed which, on sintering, approximately compensates the shrinkage to be expected from sintering.

It is theoretically possibly to produce a blank from a noble metal alloy and to tightly sinter it after it has been milled. In this way the desired final properties are imparted thereto. In the case of profile grinding production processes the actual milled item, however, makes up only approximately 20 to 30 % of the total volume of material removed. Thus it is prohibitive for economic reasons to use noble metals as blanks, especially as reprocessing of milled noble metals is particularly expensive if the shavings to be recycled are contaminated.

In general, sintered materials suffer from the drawback that, with a shrinkage of up to 30%, a comparatively large volume has to be machined by the cutting machining. Moreover, a sintering furnace is necessary which must have characteristics not otherwise required in a dental laboratory.

The object of the invention consists in the provision of a dental prosthetic item which, on the one hand, consists of a universal support material and, on the other hand, can be flexibly adapted to a majority of intended uses, and in the provision of a process in which one of the process steps causes adjustment of the final geometrical, chemical, and physical states of the intermediate article without subjecting the same to geometrical deformation and without it being necessary to remachine the same in order to impart its predefined final shape. It is particularly desirable to produce dental prosthetic items using conventional dental grinding machines without the resulting intermediate articles undergoing a change in shape during the process step by which they receive their final properties.

A further object consists in the provision of a composite material or gradient material consisting of one and the same material or of different materials, in particular high gold alloys, with the amount of alloy used, particularly noble metal alloy, being reduced to a minimum.

### SUMMARY OF THE INVENTION

The invention is based on the idea that, instead of a blank made of a material having the final material properties, a blank is machined which is not given the final material properties of the dental prosthetic item before a process of infiltration of the machined blank has been carried out. The materials thus created have novel and advantageous properties.

According to the invention, the blank intended for the production of dental prosthetic items has adequate strength for machining in machining equipment and possesses a porous skeletal structure exhibiting infiltratable cavities. Advantageously, these cavities are designed such that they are fully infiltratable.

The properties of the blank to be machined are advantageously such as to afford shape-accurate finishing using machining equipment designed for dental ceramics allowing an adequate service life of the machining tools and good handling of the work pieces whilst retaining an infiltratable, in particular open-pore, skeletal structure.

The skeletal structure of a blank produced in this manner or of an intermediate article produced by profile machining of the blank can be advantageously infiltrated with at least one further material in order to obtain the desired final properties of the required work piece without incurring any changes in the shape of the blank or an intermediate article produced by machining the blank.

According to the invention, the blank has a melting point which is higher than the melting point of the material to be infiltrated. The surface tension, the flow behavior, and the wetting ability of the materials used for the infiltration should be related to the blank such that maximum filling is achieved by the infiltrate.

Advantageously, the open-pore cavities make up from 25 to 95% of the volume of the blank, since in this range good handling of the intermediate article is possible, whilst at the same time a sufficiently high volumetric content of infiltrate is provided in the final article.

Advantageously, the composition of the skeletal structure and/or the size of the cavities is/are site-dependent. By this means the proportion of the infiltrate in the final article can be specifically influenced so as to have an effect on expansion properties and fracture mechanics.

An intermediate article produced by machining the blank can be designed in certain parts thereof such that infiltration is only possible with certain materials and only partially.

For example, the areas which, after machining, represent the occlusal and the approximal surfaces of a crown can be designed such that these surfaces cannot be wetted up to a depth of 0.2 mm by a first infiltrate, for example metal, but these surfaces faces can be wetted by a second infiltrate, e.g. by a tooth-colored plastics material, after the rest of the intermediate article has been infiltrated with the said first infiltrate. It is thus possible to provide blanks having a prefinished occlusal surface, which occlusal surface has been conditioned such that the metal to be infiltrated into the skeletal structure cannot penetrate into this region because, for example, an inhibitor has been introduced. After these blanks have been machined, it being assumed that he occlusal surface will be machined only slightly, and the machined blank (intermediate article) has been infiltrated, the occlusal surfaces will still have a porous structure. The inhibitor can now be removed from the occlusal surface and the still porous structure infiltrated, for example, with a tooth-colored composite.

Advantageously, the porous skeletal structure consists of metal or a metal-containing alloy and is particularly in the form of a metal foam. A blank of this type can be used, in particular, for the production of dental prosthetic items having a content of metallic materials. The cavities present in the skeletal structure can be filled, for example, with a noble metal, so that the desired material properties such as biocompatibility, anticorrosive properties, strength, flexural strength, hardness, and thermal expansion coefficient will be achieved without having to consider any change in the shape of the intermediate article and without it being necessary to mill off a substantial excess of material.

Moreover, the blank can contain preformed surface elements for allowing mechanical fitting of other articles and/or for providing features which cannot be produced using dental grinding machines. In this way, machining of this region will not be necessary. Such surface elements consist, in particular, of matching surfaces as are provided in implantology between implant and abutment.

Equally, in attachment technology, precise fits are produced which work on the key lock principle and are likewise advantageously realizable in the manner mentioned, since it has hitherto only been possible to make such fitting surfaces by extremely complicated means. In this way, the fitting surfaces could advantageously be formed preshaped on the block, which itself can be produced, for example, by injection molding.

These surface elements may already have been infiltrated with certain materials, for example, to provide greater strength.

The invention further relates to a dental prosthetic item consisting of a porous basic structure, whose cavities are filled with a second material.

Preferably, the first and/or second material consist(s) of metal or a metal alloy.

Furthermore, the lower limit of a filling in the dental prosthetic item is at least 25% and preferably more than 65%.

The invention also relates to a process for the production of a blank for dental prosthetic items. A solids mixture consisting of a powder mixture containing a propellant and/or a filling material is molded to a blank and subsequently the propellant and/or the filling material is/are removed therefrom to form a porous skeletal structure.

Such a powder mixture is advantageously metal-containing and, following removal of the propellant and/or filling material, there is obtained a skeletal structure in the form of a metal foam.

Advantageously, the content of propellant and/or filling material in the mixture is between 25 and 95% by volume.

Advantageously, a site-dependent composition of the mixture to give a preblank consisting of a gradient material is produced by laminate molding, sedimentation, or spraying. A gradient material is understood here as meaning a material having material properties which are subject to site-dependent variations.

Moreover, the mixture used for the production of the blank may contain a binder. The binder ensures that the mixture retains its shape during one shaping process in the production of the blank up to the next processing step.

Yet another object of the invention is the provision of a process for the production of a dental prosthetic item, in which a blank consisting of a porous material is provided which has open cavities in from 25 to 95% of its volume, in which process an intermediate article close to the final shape is produced from the blank by machining and the cavities of the intermediate article are subsequently filled with at least one filling material.

Advantageously, the filling material and/or the skeletal structure consist(s) of metal or a metal alloy, as great stability can thus be achieved.

According to one development, filling of the intermediate article can be carried out using a predefined amount of filling material, which has the advantage of facilitating the removal or recycling of any surplus material.

According to another development, first subregions of the blank and/or intermediate article are filled with a first filling material and second subregions of the blank are filled with a second filling material. By this means, specific properties of individual regions of the dental prosthetic item can be produced. One important property of a dental prosthesis is its durability and color. In this way, it is possible, for example, to prepare an inner core of metal, which is ground to exact shape on the outer surface, which surface is then filled with an infiltrate that is tooth-colored.

Advantageously, the material properties are designed such that machining of the blank for the production of the intermediate article by grinding or milling can be carried out in a grinding or milling machine suitable for machining dental ceramics.

### BRIEF DESCRIPTION OF THE DRAWINGS

Exemplary embodiments of the invention are shown in the drawings, in which:

FIG. 1 shows a blank having a porous skeletal structure in a perspective view,

FIG. 2 shows a cross section through a detail of the blank of FIG. 1, and

FIG. 3 shows a dental prosthetic item having subregions containing different filling materials.

For the production of a dental prosthetic item, a preblank is first produced which comprises metal powders of unimodal or multimodal particle sizes and/or shapes. These powders are produced, for example, by spraying or chemical deposition. Moreover, a propellant is provided which releases gas above a certain temperature, or a filling material is provided which can be removed after the formation of open cavities.

The preblank can be produced from this mixture by compaction caused by pressure or heat treatment.

If binders are added to the mixture, it can alternatively assume such a preblank form by means of injection molding, extrusion, or some other shaping process. Subsequently, the binder and/or filling material can be removed and further compaction of the blank thus obtained can, if required, be carried out by means of pressure or heat treatment.

It is essential that shaping of the preblank is carried out below the activation temperature of the propellant or the release temperature for the filling material. When a propellant is used, the preblank is finally foamed to produce the actual blank by a final heat treatment causing liberation of the gas bound in the propellant. If a filling material is used, it is removed from the preblank. In this way, a skeletal structure is produced in the blank, which contains small, open cavities, which should be as voluminous as possible and which can make up up to 95% of the volume of this blank.

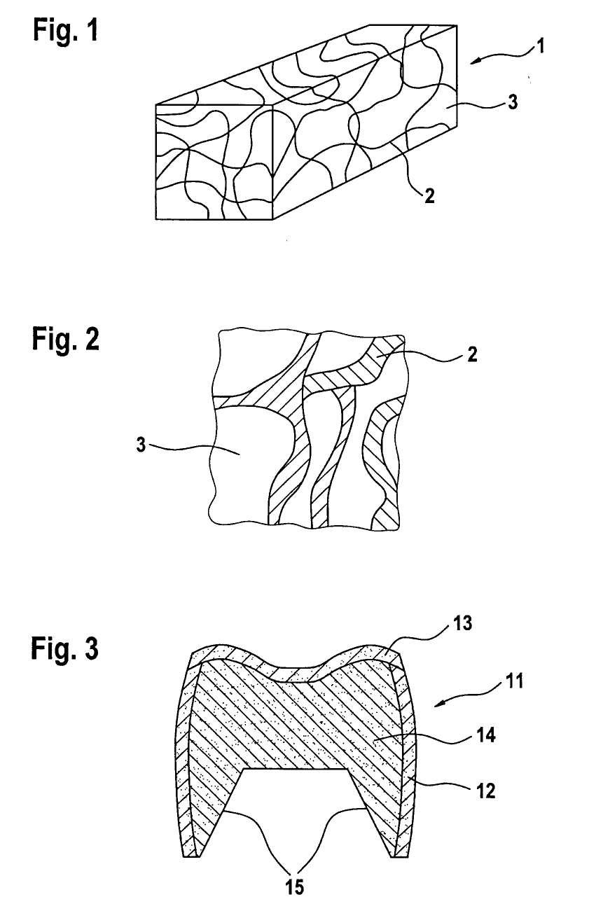

A blank 1 of this type is shown diagrammatically in FIG. 1, in which a skeletal structure 2, on the one hand, and open cavities 3 lying on the outer surface, on the other hand, can be discerned.

FIG. 2 shows a cross section through the blank of FIG. 1, the section shown being disposed in the interior of the blank. Here again, the skeletal structure 2 and cavities 3 can be clearly discerned.

The consistency of this blank is in this case adjusted, on the one hand, such that it has sufficient strength to allow machining with machining tools implementing, say, grinding or milling techniques and, on the other hand, it is adjusted such that a maximum content of open-pore hollow cavities results and is maintained during machining. It should be possible here, in particular, to effect machining with a conventional grinding or milling machine for dental ceramics without making changes to the machine and allowing an adequate service life of the machining tools.

After the blank has been given the necessary shape with specified precision, it is either completely filled with a material, such as, for example, a high gold alloy, or filled at certain sites in certain quantities to fulfill certain requirements. Thus it is possible to produce, on the one hand, a high gold dental prosthetic item, or, on the other hand, to make, for example, a dental prosthetic item in which the visible outer surfaces are filled with, say, a desired colorant such that the color of the prosthetic item will assume the color of the teeth surrounding it. Filling can be carried out, for example, by utilizing capillary forces.

The design of a dental prosthetic item is itself governed by the situation prevailing in the patient. The region to be treated is scanned, following the production of the preparation, to determine its topography. This can be done, for example, by means of a scanning camera directly in the mouth of the patient or it can be carried out indirectly with the aid of a positive or negative impression of this region.

Afterwards, modeling of the work pieces is carried out with the aid of known process. As a rule, this is carried out by means of computer-assisted processes. After designing the dental prosthetic item in its final dimensions, the porous blank is machined to these dimensions by removal of material.

By means of an infiltration process, the open-pore skeletal structure of the machined blank is filled with a further, flowable material, to impart final properties to the work piece.

To this end, the blank machined to its final dimensions can be placed in an accurately weighed amount of a melt of, for example, a high gold alloy. Due to capillary action, the pores of the material will be completely filled with the melt. A structure is thus produced which comes near to a high gold cast filling.

Owing to the invention, machining equipment for dental ceramics will also open up the field of high gold metallic restorations and allow high gold caps and frameworks to be produced in a rational manner using CAD/CAM machines. To this end, it is not the alloy itself with its final material properties which is machined, but rather a precursor thereof. The process produces an intermediate article which, unlike sintered dental prosthetic items, is imparted with its final properties by a shape-retaining process.

In FIG. 3, a dental prosthetic item 11 is shown in which in the region of the outer surfaces 12, 13 a first filling material has been introduced into the skeletal structure and a second filling material into the inner region 14.

By this means, the possibility of producing genuine composite or gradient materials is opened up, which materials can have better properties for restoration technology than previously known materials.

Very particularly, it should be noted that filling of the skeletal structure with plastics is likewise possible.

It is also possible to make use of inhibitors in order to infiltrate the material on the visible surfaces with a tooth-colored filling material and the material in the interior of the machined blank with some other filling material. An inhibitor is understood here as meaning a substance which increases the surface tension of the inner surface of the skeletal structure such that the infiltration material does not rise further into the skeletal structure without exerting increased force. This technique is known per se.

Moreover, on the dental prosthetic item 11 there are present preformed surface elements 15 already integrated in the blank, which surface elements can be implemented to create a mechanical fit relative to another article, such as an abutment.

A customary CoCrMo alloy which is used in dental prosthetics, e.g. Remanium 800 from Dentaurum, is converted into a spherical powder with the aid of an atomizing process. The powder is fractionated and the proportion of the powder having a diameter of <45 μm is selected for use. This powder is then treated with a wax-like binder and a spacer having diameters between 20 and 150 μm. From these constituents, granules are prepared which are shaped by injection molding to give blocks (blanks). The blocks are subjected to incipient sintering, which causes the binders and spacers to volatilize. A blank having a pore content of between 25 and 95% remains.

From this blank, a true-to-size intermediate part for dental prosthetic items such as caps and bridge frameworks is produced by means of known CAD/CAM processes.

The intermediate part is then placed in a crucible together with an accurately weighed amount of a dental gold alloy. The amount of gold needed depends on the weight of the cap. The crucible is heated in an oven so that the gold liquefies. The gold is drawn into the framework by means of capillary forces.

1-21. (canceled)

22. A blank for the production of dental prosthetic items, exhibiting sufficient stability for material-removing machining in machining equipment, wherein the blank exhibits a porous skeletal structure comprising infiltratable cavities and consisting of metal or a metal alloy.

23. A blank as defined in claim 22, wherein a melting point thereof is higher than the melting point of the material to be infiltrated.

24. A blank as defined in claim 22, wherein the cavities make up from 25 to 95% of the volume of said blank.

25. A blank as defined in claim 22, wherein the composition of the skeletal structure and/or the size of the cavities is/are site-dependent.

26. A blank as defined in claim 22, including preformed surface elements which can be implemented for creating a mechanical fit relative to other articles and/or which exhibit features that cannot be produced with machining equipment.

27. A process for the production of a blank for dental prosthetic items, comprising shaping a solids mixture consisting of a powder mixture containing a propellant and/or a filling material to produce a preblank, and removing said propellant and/or said filling material to produce a porous skeletal structure.

28. A process as defined in claim 27, wherein the blank, following removal of said propellant and/or said filling material, has an open-pore skeletal structure in which cavities make up from 25 to 95% of a volume thereof.

29. A process as defined in claim 28, wherein said powder mixture contains metal and, following the removal of said propellant and/or said filling material, a skeletal structure in the form of a metal foam remains.

30. A process as defined in claim 29, wherein the content of propellant and/or filling material in said solids mixture is between 25% and 95%, by volume.

31. A process as defined in claim 30, wherein a site-dependent composition of said solids mixture is processed by laminate molding, sedimentation, or spraying form to a preblank consisting of a gradient material.

32. A process as defined in claim 31, wherein said solids mixture contains a binder.

33. A process for the production of a dental prosthetic item, comprising the steps of
providing a blank exhibiting a porous skeletal structure and having open cavities making up from 25 to 89% of its volume,
machining said blank to produce an intermediate article approximating a final shape, and
filling the cavities of said intermediate article with at least one filling material, said filling material and/or said skeletal structure consisting of metal or a metal alloy.

34. A process as defined in claim 33, wherein filling of said intermediate article is carried out using a specified amount of filling material.

35. A process as defined in claim 34, wherein first subregions of said blank and/or of said intermediate article are filled with a first filling material and second subregions of said blank and/or said intermediate article are filled with a second filling material.

36. A process as defined in claim 35, wherein said machining of said blank is carried out by grinding or milling in a grinding or milling machine suitable for machining dental ceramics.

37. A process as defined in claim 36, wherein said cavities are homogeneously filled with filling material.
